(19) United States
(12) Patent Application Publication
(10) Pub. No.: US 2020/0404194 A1
(43) Pub. Date: Dec. 24, 2020

(54) REFLEX SIGHT INCORPORATING AN INFRARED CAMERA

(71) Applicant: Meopta U.S.A., Inc., Trinity, FL (US)

(72) Inventor: Philip E. Buchsbaum, Oldsmar, FL (US)

(21) Appl. No.: 16/409,990

(22) Filed: May 13, 2019

Related U.S. Application Data
(60) Provisional application No. 62/671,581, filed on May 15, 2018.

(51) Int. Cl. H04N 5/33; G02B 27/10; G02B 27/01

(52) U.S. Cl. CPC H04N 5/33; G02B 27/0101; G02B 27/10

(57) ABSTRACT

A reflex sight that incorporates an Infrared or low light camera using one, or any combination of, VIS-NIR, NIR, SWIR, LWIR and VLWIR wavelength ranges such that the IR image is projected by a Heads Up Display through a beamsplitter and onto the surface facing the observer of the sight's reflective optic giving the sight Infrared sighting capabilities is disclosed.

### CROSS-REFERENCE TO RELATED APPLICATION

The present application claims the benefit of previously filed co-pending Provisional Patent Application, Ser. No. 62/671,581, filed on May 15, 2018.

### FIELD OF THE INVENTION

The method of this disclosure belongs to the field of sighting instruments. More specifically it is a reflex sight that incorporates an Infrared or other low light camera such that the Infrared (IR) or other low light image is projected onto the sight's reflective optic giving the sight Infrared or other low light sighting capabilities.

### BACKGROUND OF THE INVENTION

A reflex (or reflector) sight is an optical device that allows the user to look through a partially reflecting glass element and see an illuminated projection of an aiming point or some other image superimposed on the field of view. These sights work on the simple optical principle that anything at the focus of a lens or curved mirror (such as an illuminated reticle) will look like it is sitting in front of the viewer at infinity. Reflector sights employ some sort of “reflector” to allow the viewer to see the infinity image and the field of view at the same time, either by bouncing the image created by a lens off a slanted glass plate, or by using a mostly clear (partially reflective) curved glass reflector that images the reticle while the viewer looks through the curved glass reflector. Since the reticle is at infinity it stays in alignment with the device the sight is attached to regardless of the viewer's eye position, removing most of the parallax and other sighting errors found in simple sighting devices.

Since their invention in 1900, reflex sights have come to be used as gun and rifle sights on all kinds of weapons and are also used as the base component in many types of modern heads-up displays. They have been used in weapons such as anti-aircraft gun sights, anti tank gun sights, and any other role where the operator had to engage fast moving targets over a wide field of view, and the sight itself could be supplied with sufficient electrical power to function. There was some limited use of the sight on small arms after World War 11 but it came into widespread use after the late 1970s with the invention of the red dot sight, with a red light emitting diode (LED) as its reticle, making a dependable sight with durability and extremely long illumination run time. Reflex sights are also used in civilian applications such as sights on surveying equipment, optical telescope, pointing aids, and camera viewfinders.

A thermographic camera (also called an Infrared camera or thermal imaging camera) is a device that forms an image using Infrared radiation, similar to a common camera that forms an image using visible light. Instead of the 400-700 nanometer range of the visible light camera, Infrared cameras operate in wavelengths as long as 14,000 nm (14 μm). Their use is called thermography. The IR spectrum can be subdivided into 5 regions, although this definition is somehow arbitrary and it differs from one author to another. The Near Infrared (NIR) band is mostly used in fiber optic telecommunication systems since silica (SiO₂) provides a low attenuation losses medium for the infrared, whilst the Short Wave Infrared (SWIR) band allows to work on long-distance telecommunications (remote sensing) using a combinations of detector materials. The Medium Wavelength Infrared (MWIR) and the Long Wavelength Infrared (LWIR) bands find applications in Infrared Thermography for military or civil applications, e.g. target signature identification, surveillance, Non-Destructive Evaluation, etc. The Very Long Wavelength Infrared (VLWIR) band is used in spectroscopy and astronomy. Unlike Mid-Wave Infrared (MWIR) and Long-Wave Infrared (LWIR) light, which is emitted from the object itself, SWIR is similar to visible light in that photons are reflected or absorbed by an object, providing the strong contrast needed for high resolution imaging. Ambient starlight and background radiance (nightglow) are natural emitters of SWIR and provide excellent illumination for outdoor, nighttime imaging. Infrared cameras exist for use in any of the IR wavelength subdivisions discussed above. Additional low light cameras are known in the art such as a low light CMOS camera that works in the VIS to NIR wavelengths that would provide the same advantages in a low light sighting situation as an Infrared camera.

There is nothing novel about a compound sighting device of a reflex sight and IR camera as these combinations can be found in prior art such as Mauricio (U.S. Pat. No. 8,915,008), which discloses the general idea but couples an image into a beamsplitter assembly, and Hammond (U.S. Pat. No. 10,126,099), which is quite recent and includes reflex sites, but the image is projected though an optical relay system onto a reflective optic via a prism. Applicant's compound sighting device is accomplished in a much simpler manner than the prior art. In Applicant's system the IR or low light imager is projected onto the semi reflective optic from the same direction as the observer. Thus, there is only one piece of glass, the a mostly clear (partially reflective) curved glass reflector, in the entire system as discussed below and shown in FIG. 1. This novel design approach means that without all the relay optics the Applicant's combined reflex sight with Infrared or low light camera achieves the same result at a much lower BOM (Bill of Materials) cost than the prior art systems. The significant difference of Applicant's design compared to the prior art is the simplicity of design and the directionality of the imager.

The invention of this disclosure is useful for a variety of research and scientific, business, surveillance, and Close Quarters Combat (CQC) situations such as home protection and law enforcement. Thus, there is a need for an improved reflex sight that incorporates IR or other low light viewing as the infinity image.

### BRIEF SUMMARY OF THE INVENTION

A reflex gun sight that incorporates an Infrared or low light camera such that the IR or other low light image is projected onto the sight's reflective optic giving the sight Infrared or low light sighting capabilities.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a preferred embodiment optical diagram of the combined reflex sight and IR or other low light camera of this disclosure.

### DESCRIPTION OF THE PREFERRED EMBODIMENT

As mentioned above, one of the uses for the invention of this disclosure is a CQC situation for home protection and law enforcement as further described in the preferred embodiment below. In the preferred embodiment the reflex sight is mounted on a shotgun, rifle or pistol and if someone breaks into a house at night the occupant could turn on the IR or other low light camera and any low light or heat source, even hiding behind a curtain or furniture if using IR, can be seen and targeted.

As is well known in the prior art reflector sights work by using a lens or an image-forming curved mirror with a luminous or reflective overlay image or reticle at its focus, creating an optical collimator that produces a virtual image of that reticle. The image is reflected off some form of angled beam splitter or the partially silvered collimating curved mirror itself so that the observer (looking through the beam splitter or mirror) will see the image at the focus of the collimating optics superimposed in the sight's field of view in focus at ranges up to infinity. Since the optical collimator produces a reticle image made up of collimated light, light that is nearly parallel, the light making up that image is theoretically perfectly parallel with the axis of the device or gun barrel it is aligned with, i.e. with no parallax at infinity. The collimated reticle image can also be seen at any eye position in the cylindrical volume of collimated light created by the sight behind the optical window. But this also means, for targets closer than infinity, sighting towards the edge of the optical window can make the reticle move in relation to the target since the observer is sighting down a parallel light bundle at the edge. Eye movement perpendicular to the device's optical axis will make the reticle image move in exact relationship to eye position in the cylindrical column of light created by the collimating optics.

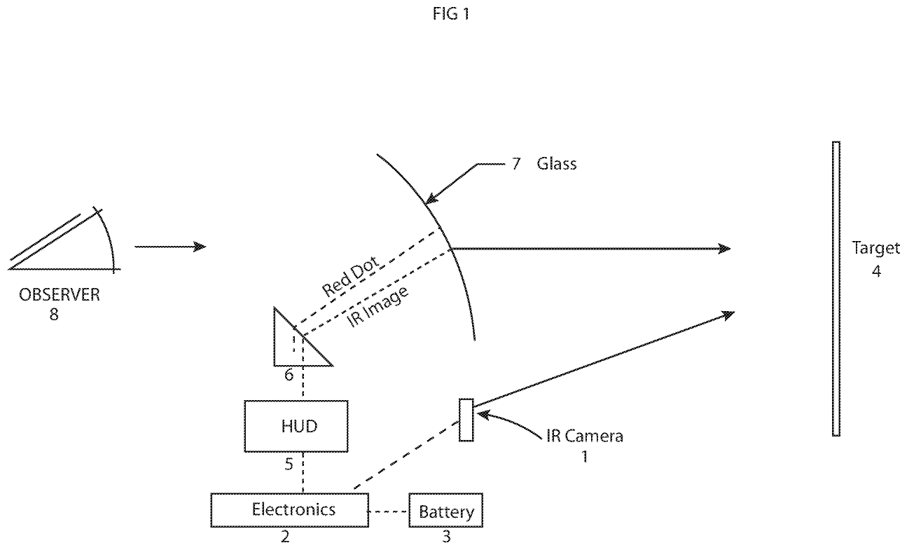

As shown in the preferred embodiment optical diagram of the combined reflex gun sight and IR or other low light camera of FIG. 1 the novel idea of this disclosure is a reflex gun sight as described above that incorporates an Infrared or other low light camera using one, or any combination of, VIS-NIR, NIR, SWIR, MWIR, LWIR and VLWIR wavelength ranges, also as described above, such that the target IR or low light image is projected onto the sight's reflective optic giving the sight Infrared sighting capabilities. More specifically the preferred embodiment is an IR or low light camera (1) mounted on and aligned with the gun barrel (not shown), along with its associated electronics (2) and battery (3). The IR or other low light camera (1) then forms an Infrared or low light image of the target (4) and the image from the IR or other low light camera (1) is projected by use of a heads up display (5) that creates a visible light image, through a beam splitter (6) onto the surface facing the observer of the mostly clear curved glass reflector (7) that images the reticle while the observer (8) looks through the mostly clear curved glass reflector (7) at the target (4).

Since certain changes may be made in the above described reflex sight that incorporates an Infrared or low light camera using one, or any combination of, VIS-NIR, NIR, SWIR, MWIR, LWIR and VLWIR wavelength ranges such that the IR or low light image is reflected onto the sight's reflective optic giving the sight Infrared or low light sighting capabilities without departing from the scope of the invention herein involved, it is intended that all matter contained in the description thereof or shown in the accompanying figures shall be interpreted as illustrative and not in a limiting sense.

What is claimed is:

1. A combination reflex sight and camera sighting device for viewing an object comprising:
said reflex sight having a partially reflective optically collimating curved glass reflector that an observer can view said object through;
wherein said partially reflective optically collimating curved glass reflector images a reticle at the focus on the surface facing the observer of said partially reflective optically collimating lens or curved glass reflector;
said camera aligned with said reflex sight such that it aims on said object; and,
said camera capturing an image of said object and using an image projector to project a visible light image of said object through a beam splitter and onto said surface facing the observer of said a partially reflective optically collimating curved glass reflector wherein said visible light image is reflected off said surface facing the observer of said a partially reflective optically collimating curved glass reflector and is viewed by the observer as an infinity image.

2. The combination reflex sight and camera sighting device of claim 1 wherein said image projector is a Heads Up Display.

3. The combination reflex sight and camera sighting device of claim 2 wherein said a partially reflective optically collimating curved glass reflector is a partially silvered collimating curved mirror.

4. The combination reflex sight and camera sighing device of claim 3 wherein said camera is capturing one, or any combination of, Visible to Near Infrared, Near Infrared, Short Wavelength Infrared, Medium Wavelength Infrared, Long Wavelength Infrared, and Very Long Wavelength Infrared wavelength ranges.
